(19) United States
(12) Patent Application Publication
(10) Pub. No.: US 2012/0064331 A1
(43) Pub. Date: Mar. 15, 2012

(54) METAL LAMINATION FILM

(75) Inventors: Scott W. Wollack, Peru, IL (US); Thomas H. Malpass, Ottawa, IL (US)

(73) Assignee: TEE GROUP FILMS, INC., Ladd, IL (US)

(21) Appl. No.: 13/229,421

(22) Filed: Sep. 9, 2011

Related U.S. Application Data
(60) Provisional application No. 61/382,272, filed on Sep. 13, 2010.

(51) Int. Cl. B32B 15/08; B21C 37/06; B32B 7/12; B32B 37/06; B32B 25/00; B32B 25/04

(52) U.S. Cl. 428/323; 428/349; 428/344; 156/321; 72/368

(57) ABSTRACT

A polymer film is provided for use with metal sheeting and includes a thermoplastic adhesive having an adhesive layer and an outer layer. The polymer film is mechanically and chemically bonded to the metal sheeting through use of heat lamination of the thermoplastic adhesive layer. The thermoplastic layer includes an extrudable thermoplastic resin reacted with a polar compound, and contains a particulate filler, and optional quantities of an additional thermoplastic resin. The polymer film can be of a single or multi-layer construction, with one layer containing a thermoplastic adhesive polar compound, which is heat laminated to the metal sheet, a core layer that can be modified to change the performance and characteristics of the film, and an outer layer composed of a high abrasion and impact resistant polymer. The polymer film provides the metal sheeting with increased protection from the elements, low friction surface, resistance to chemicals and abrasion.

The present application claims priority to U.S. Provisional Patent Application Ser. No. 61/382,272 filed on Sep. 13, 2010, which is herein incorporated by reference.

### BACKGROUND

Large diameter pipes are manufactured by forming metal sheeting into pipe which can be used in a variety of applications. In one such application pipe is formed for use as underground culvert pipes. In order to increase the life of the pipes, liquid tar has been applied to the metal to form a water resistant barrier. Overtime the tar degrades, becomes brittle and cracks, which exposes the metal surface of the pipe leaving it vulnerable to corrosion. Currently in the industry the majority of metal sheeting is primed and painted or a polymer film is attached to the metal using chemical primers and glues. Chemical primers and glues all give off vapors which need to be monitored for environmental and health concerns and some are controlled by environmental agencies.

Dow Chemical™ developed a thermoplastic adhesive film, sold under the name Trenchcoat™, which could be laminated to the surface of the metal sheeting and be used in place of the tar. Improvements however can be made to bond strength, melting point, chemical resistance, and vapor protection of the thermoplastic adhesive to adequately protect the metal pipes. For the desired purpose, the polymer film should not separate from the metal it is bonded to even after being exposed to weathering, a salt brine solution, and chemical agents, such as sulfuric acid, peroxides, herbicides, and pesticides. Second, the film must be able to bend and curve without the film “cracking or crazing” potentially exposing the metal surface. Third, the film must withstand intensive abrasion resistance for applications such as culvert pipes where large rock, tree limbs, and other debris is washed through the pipe scratching and abrading the polymer film surface. The present disclosure meets or exceeds these requirements.

### SUMMARY

According to the present disclosure, a polymer film is configured to be applied to metal that can be used to form piping and other structures. The polymer film is designed to reduce corrosion to the metal and increase the life of the metal over time.

In illustrative embodiments, the polymer film includes a thermoplastic adhesive that can bond to metals and includes a highly abrasion resistant, low friction outer surface. The polymer film imparts properties onto the metal sheet which are highly desirable by end users when the metal sheet is formed into piping. Further the thermoplastic adhesive creates a nearly unbreakable chemical bond between the polymer backbone and the metal.

In illustrative embodiments a protective film or sheet is made up of single or multiple layers and includes at least one layer that contains a thermoplastic adhesive, which can be laminated to metal sheeting through use of heat and pressure. The finished product can be formed into piping for use as culverts. The thermoplastic adhesive layer is preferably a polar compound made from maleic anhydride. The thermoplastic adhesive layer may contain particulate filler or can be rubber modified and may contain additional thermoplastic resin layers.

In illustrative embodiments, an extrudable polymer backbone reacts with a polar functional moiety capable of forming covalent bonds between the polymer and the metal. This polar functional moiety can further be diluted with various thermoplastic extrudable polyolefin materials. The adhesive composition may also contain from about 0.1% to about 75% by weight particulate filler, capable of reacting in part with the polar functional moiety. This in turn opens up ionic bonding sites in the form of anions on the particulate filler allowing ionic bonding to occur to the cations in the metal. The particulate filler is not necessary to achieve optimal bond strength to the metal sheet. The above polar functional moiety is sufficient but the particulate filler imparts certain chemical and mechanical properties which are highly desirable. Optionally an additional quantity of thermoplastic extrudable polyolefin material making up the remainder of the volume can be used if desired.

The adhesive composition, when optimized, allows for a polar covalent chemical bond to form between the polymer backbone and the metal via the functional moiety. By definition, a polar covalent bond allows each atom to have a residual or partial charge, but unlike ionic bonding, electrons are shared not transferred. Further, through the use of particulate fillers, which have the potential to contain charged electrons, incorporated into the film structure, an ionic bond can form between the particulate filler and the metal. The ionic bond by definition is a complete or near complete transfer of an electron. This is allowed as a given percentage of the polar functional moiety in the thermoplastic adhesive that will polar covalent react and bond to atoms in the particulate filler. Once a polar covalent bond is formed, a negative charge is left on the particulate filler, which is a bonding site for the positive charged cations in the metal.

This chemical reaction is generally achieved by the use of anhydrides, esters, and amides; metal salts of unsatured carboxylic acids; and imides placed into the polar functional moiety. The result is a reaction with a hydrogen atom or alcohol group on the particulate filler in a redox reaction forming an acid. The removal of the hydrogen atom from the particulate filler will leave a negative charge on the remaining particulate filler molecule.

With the foregoing in mind, the polymer film of the present disclosure provides a nearly unbreakable chemical bond between the metal and the polymer film which can withstand weathering, chemical exposure, bending & forming, and abrading. The polymer film can be laminated to metal sheeting in a one step process through the use of heat only. The particulate filler in the thermoplastic extrudable adhesive composition imparts the melting of the thermoplastic by reducing the energy requirement (Joules/gram) to achieve melting of the thermoplastic. The particulate filler retains the energy transferred into the polymer film longer than the base thermoplastic material. The energy in the particulate filler is given off in the form of heat. This increases the time the base thermoplastic material is in a molten state allowing for further covalent and ionic bonding to occur to increase the strength of the overall bond of the polymer to the metal.

The particulate filler in the thermoplastic extrudable adhesive composition of the present disclosure, by imparting the melting of the thermoplastic by reducing the energy requirement (Joules/gram) to achieve melting of the thermoplastic, allows for faster lamination speeds of the polymer film. Through the use of high density polyethylene or homopolymer polypropylene as the outer surface, the abrasion resistant is greatly increased and the overall friction of the surface is reduced allowing for easier pipe forming and transportation of debris through the pipe.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an illustration used to show the different layers of the protective film and is not to scale;

FIG. 2 is an illustration used to show the process of laminating a pair of protective film layers to both sides of a metal layer;

FIG. 3 is an illustration used to show the metal layer having the thermoplastic film layers bonded to the metal layers; and

FIG. 4 is a perspective view showing the polymer film being applied to an already formed pipe.

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure and is not intended to limit the disclosure to the details of construction and the arrangements of components set forth in the follow description or illustrated in the drawings.

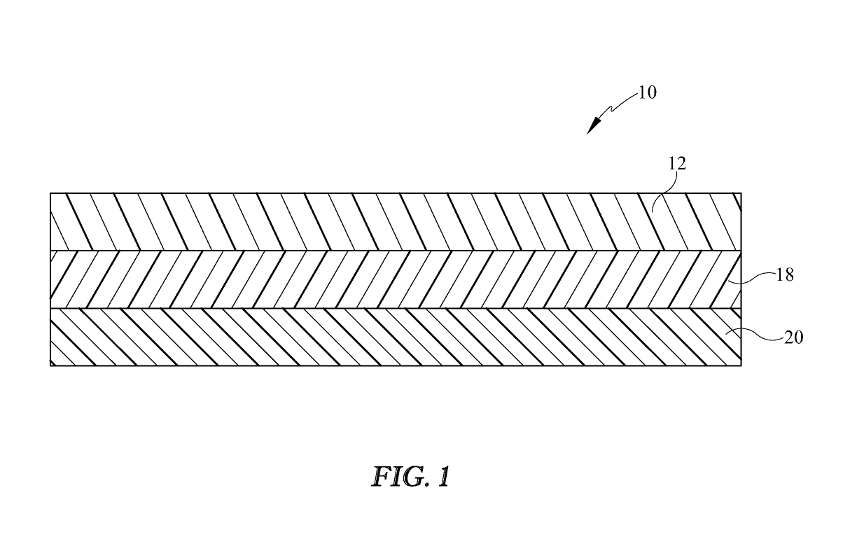

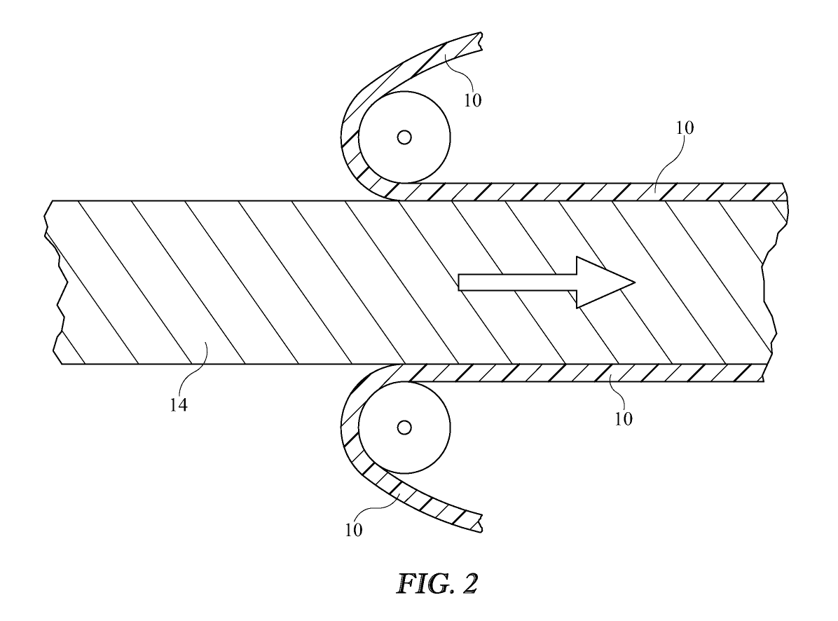

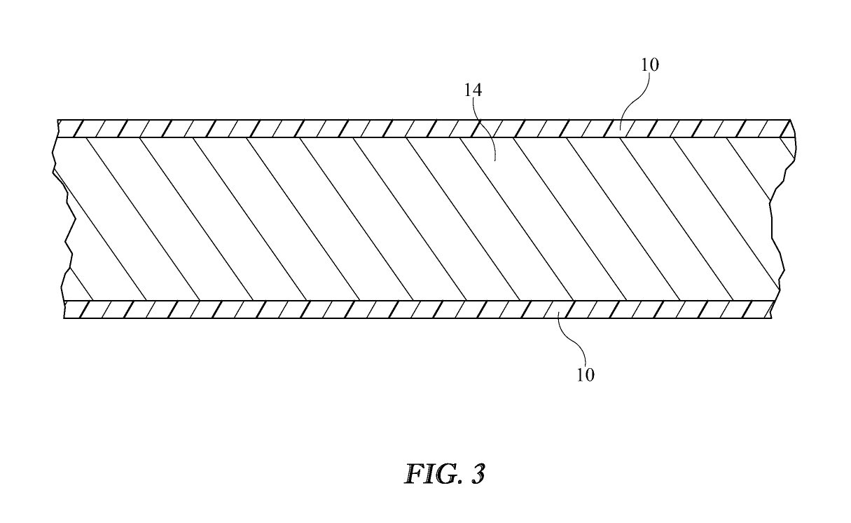

A protective film or sheet 10 is made up of single or multiple layers and includes at least one thermoplastic adhesive layer 12 that contains a thermoplastic adhesive, as shown in FIG. 1 for example. The protective film 10 can be laminated to metal sheeting substrate 14 through use of heat and pressure that can be used to form a finished product that is formed into piping for use as culverts, as shown in FIGS. 2 and 3 for example. The thermoplastic adhesive layer 12, in one example can be a high density polyethylene (HDPE) and is preferably a polar compound made from maleic anhydride. The thermoplastic adhesive layer 12 may contain a particulate filler or be rubber modified and may contain additional thermoplastic resin layers.

The polar compound allows for an actual chemical bond to be created between the thermoplastic adhesive material and the metal surface. The maleic anhydride attacks the surface of the metal allowing the polar portion of the molecule to attach to the metal molecule. If a particulate filler is added to the thermoplastic adhesive layer 12, the particulate filler will allow the thermoplastic adhesive to become molten with less energy when heat is applied. If the thermoplastic adhesive layer 12 is rubber modified the energy input into the polymer will distribute more evenly allowing for a more consistent bond with the metal substrate 14.

The film or sheet can be manufactured as either a single layer film or can be manufactured as multi-layer film with varying properties. When manufactured in the form of a multi layer film the thermoplastic adhesive layer 12 can compose from about 0.01% to about 97% of the overall volume. In one process, individual film layers can be extruded to form a multi-layer film. In another type of process, individual film layers may be extruded separately and bonded together at a later stage. The film may include an embossed pattern to reduce the surface friction and increase surface area.

The thermoplastic adhesive layer 12 is configured to sufficiently bond to the metal substrate 14 without delaminating and can withstand various common chemicals and protects the resultant metal pipe formed from the elements as it is used outdoors. The thermoplastic adhesive layer 12 also sufficiently bends and stretches during the forming of the pipe.

The adhesive component used in the manufacture of the film includes an active ingredient based on an extrudable polymer or copolymer backbone which is grafted or otherwise reacted with a polar monomer to impact a polar functionality of the adhesive. Suitable base polymers include but are not limited to polyethylene, polypropylene, and ethyl-vinyl acetate. Of the several types of moieties which can be grafted or reacted to the polymer backbone maleic anhydride is preferred with concentration of about 0.01% to about 15% by weight of the polymer backbone. Overall, the active ingredient, herein defined as one of the polymers stated above reacted with a functional moiety, constitutes from about 1% to about 97% by weight of the adhesive composition.

Maleic Anhydride is a preferred active ingredient because of its ability to react with a variety of base polymers. The base polymers have varying characteristics, including but are not limited, to melting point, vapor transmission, and chemical resistance. These characteristics allow the protective film or sheet 10 to be altered to meet varying field requirements or based on the type of base polymer selected. This is advantageous because some applications of the laminated pipe may expose the polymer to heated liquids, various chemicals, high ultraviolet rays and areas of constant high humidity. Selecting the correct base polymer, which is grafted to the maleic anhydride adhesive layer 12, will increase the overall life of the laminated pipe compared to standard off the shelf protective film products.

A particulate filler added into the thermoplastic adhesive layer 12 reduces the amount of required energy that is needed to allow the thermoplastic adhesive layer 12 to become molten. The particulate filler does not reach its melting point given the amount of heat and energy applied and the overall volume of material which will become molten and is limited to the thermoplastic adhesive material.

As the thermoplastic adhesive layer 12 cools, the energy stored in the particulate filler is transferred into the thermoplastic adhesive in the form of heat. The release of heat from the particulate filler increases the amount of time required for the thermoplastic adhesive layer 12 to fully solidify and allows the polar molecules in the compound more time to react with the surface of the metal and setup a chemical bond thus creating a stronger bond between the thermoplastic adhesive layer 12 and the metal layer 14.

Particulate fillers can be organic and inorganic and include, but are not limited to, talc, mica, alumina, wallastonite, clay, glass, sheres, silica, titania, wood flour, and mixtures thereof. Talc is the presently the preferred filler. Other fillers are less preferred due to their reactivity with the polar compound making the material inert. The particulate filler can comprise from about 3% to about 75% by weight of the total adhesive.

Several types of extrudable thermoplastic adhesives do not contain a filler component. However, some of these thermoplastic adhesives can be mixed with a particulate filler in the amounts stated above to create an adhesive composition that could be used in this application. These include but are not limited to Dow Primacore™, DuPont Admer™, DuPont Nucrel™, Equistar Plexar™, Dow Rohm & Hass Tymor™, Exxon Optima™, and Westlake Tymax™. The use of a particulate filler with these thermoplastic adhesives would fall within the scope of the disclosure.

The thermoplastic adhesive material can further be modified with the use of rubber. The rubber is generally an ethylene propylene diene Monomer (M-class) rubber (EPDM) but less common rubber types such as styrenes have been used. The rubber can be added either before or during the film manufacturing process. The EPDM can constitute from about 0.5% to about 15% by weight of the total adhesive.

When heat and energy are applied to the thermoplastic adhesive material the rubber component will initially take longer to absorb the energy. Once the energy starts to be absorbed the rubber component will evenly dispersed the energy throughout the film. Even heat distribution ensures that one section of the film 10 does not take in more energy than is required to allow for the thermoplastic adhesive to melt to activate the polar compound. This results in even bond strength of the polymer film 10 to the metal 14 across the area of the metal surface.

An example polymer film 10 used for lamination to a metal substrate consisted of three layers and had an overall thickness of approximately 6 mils, as shown, for example, in FIG. 1. The adhesive layer 12 was a blend of HDPE, maleic anhydride adhesive rubber modified, and a talc filler. The core layer 18 was a blend of HDPE, black pigment and a UV inhibitor. The outer layer 20 was a blend of HDPE, black pigment and a UV inhibitor. The polymeric adhesive was approximately 50% of the adhesive layer 12 and approximately 17% of the overall film. Thus, approximately 8.3% of the overall film was an adhesive. The talc filler was 6% of the first layer, which was approximately 1% of the overall film. The rubber was added at the compounder and was approximately 5% of the polymeric adhesive.

In this example, the oven used was set to 400° F. The metal exiting the oven was approximately 350° F. when the film was applied. Acceptable ranges for ideal bond strength using a HDPE base in the first layer would be from about 300° F. to about 450° F. The acceptable ranges for LDPE or LLDPE would be from about 275° F. to about 450° F. The acceptable ranges for PP would be from about 350° F. to about 500° F.

Referring to FIGS. 1 and 2, a multi-layer polymer film, generally designated as 10, is shown in a cross sectional view. Film 10 contains three components, a thermoplastic adhesive layer 12 configured to sufficiently bond to the metal substrate 14 without delaminating, a core layer 18, and an outer layer 20 composed of either high density polyethylene or homo-polymer polypropylene containing color pigmentation, anti-oxidants, ultra violet light inhibitors and other additives commonly used by those in the art to improve weathering and abrasion resistance of the outer surface. The core layer 18 can be the same composition as the outer layer 20 or can be changed using various polymeric technology in order to improve performance of the overall polymer film 10 depending on the final article application and environmental location

In the preferred embodiment shown, the thermoplastic adhesive layer, 12 of the polymer film 10, is placed down against the metal sheet surface, as shown, for example, in FIG. 2. The remaining layers, 18 and 20, can be used to reinforce the adhesive layer, 12, and can also be modified to improve the performance of certain characteristics such as heat, abrasion and chemical resistance. The metal sheet 14, as shown in FIG. 2, is passed through an oven heated in a range from about 350 to about 600 degrees Fahrenheit. As the metal sheet 14 leaves the oven a given amount of heat is lost to the environment. The polymer film 10, in roll form, is unwound with the thermoplastic adhesive layer, 12, facing toward the metal surface and the polymer film 10 is applied to the surface.

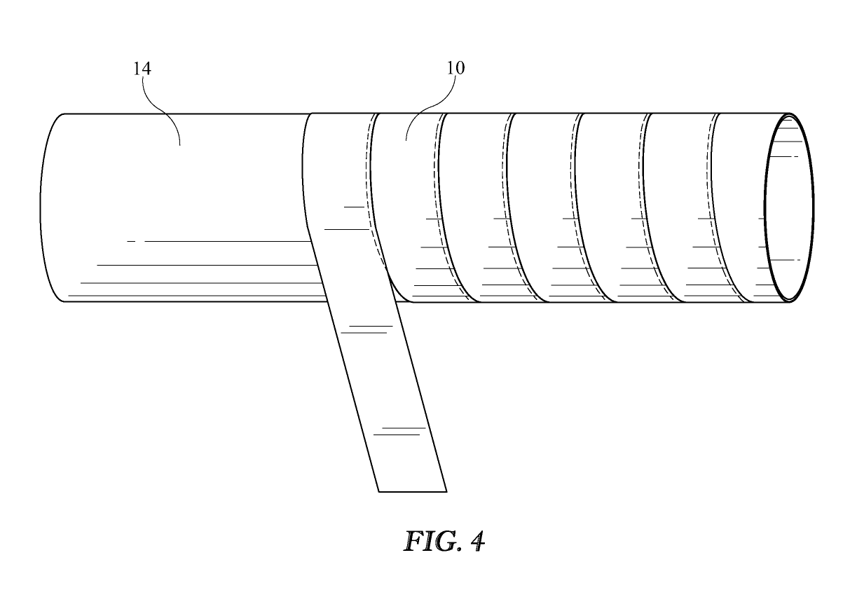

The metal surface 14 can be constructed of any metal commonly used in sheeting, including but not limited to steel, cooper, aluminum, zinc, and various other metals and metal alloys. Currently, twelve to sixteen gauge galvanized steel sheeting is preferred for conversion of the metal sheet 14 into piping. In applications where the pipe has already been formed from the metal sheet 14, the formed pipe is passed through an oven, as stated above, and the heated pipe is rotated as the polymer film 10 is unwound and spiraled around the outer surface of the pipe, taking care that the edges of the polymer film 10 overlap, as shown in FIG. 4. In the case where the pipe is already formed only the outer surface is laminated.

The thermoplastic adhesive layer 12 of polymer film 10 employs a polar functionality which chemically reacts with a thin oxide coating appearing on the surface of most metals. Therefore, any metal or alloy which forms an oxide on its surface can be employed with the polar moiety aspect of this disclosure. Further, through the use of particulate fillers incorporated into the film structure, an ionic bond can form between the particulate filler and the metal sheet 14. The ionic bond, by definition, is a complete or near complete transfer of an electron. This is allowed as a given percentage of the polar functional moiety in the thermoplastic adhesive layer 12 will polar covalent react and bond to atoms in the particulate filler. Once a polar covalent bond is formed, a negative charge is left on the particulate filler which is a bonding site for the cations in the metal sheet 14. This process is generally achieved by the use of anhydrides, esters, and amides, metal salts of unsaturated carboxylic acids and imides placed into the polar functional moiety. The result is a reaction with a hydrogen atom or alcohol group on the particulate filler in a redox reaction forming an acid. The removal of the hydrogen atom from the particulate filler will leave a negative charge on the remaining particulate filler molecule.

Ionic bonding occurs between the particulate filler and the metal sheet 14 because metals are characterized by having a small number of electrons in excess of a stable, closed-shell electronic configuration. As such, they have the tendency to lose these extra electrons in order to attain a stable configuration, a property known as electro-positivity. After the particulate filler is reacted with the polar moiety the reacted particulate filler contains an atom that is characterized by having an electron configuration just a few electrons short of a stable configuration. As such, they have the tendency to gain more electrons in order to achieve a stable configuration. This tendency is known as electro-negativity.

When a highly electropositive metal is combined with a highly electronegative particulate filler, the extra electrons from the metal atoms are transferred to the electron-deficient non-metal atoms. This reaction is between metal cations and nonmetal anions, which are attracted to each other to form a metal salt. The adhesive composition used in the disclosure includes an active ingredient based on an extrudable polymer or copolymer backbone which has been grafted or otherwise reacted with a polar monomer to impart a polar functionality to the adhesive. Suitable polymer backbones include thermoplastic materials such as polyethylene, polypropylene, and copolymers of ethylene with other alpha-olefins, copolymers of propylene and with other alpha-olefins, copolymer of ethylene with ethylenically unsatured esters and their derivatives, and mixtures including any of these polymers.

Typical functional moieties which can be reacted with the polymer backbone to impart polarity include unsatured carboxylic acids, functional derivatives of the carboxylic acids including anhydrides, esters, and amides; metal salts of unsatured carboxylic acids; and imides. Of these, maleic anhydride is especially preferred. The maleic anhydride or other functional moiety can be thermally grafted, solution polymerized, or otherwise reacted onto the polymer backbone at a concentration of about 0.01% to about 15% by weight of the polymer backbone, preferable from about 0.5% to about 10% by weight of polymer backbone, most preferable from about 1% to about 5% by weight of the polymer backbone. Overall, the active ingredient (defined as polyoefin reacted with functional moiety) constitutes from about 1% to about 97% by weight of the adhesive composition, with preferred amounts varying depending on the amount and type of the functional moiety reacted with the polymer backbone.

The adhesive composition disclosed herein may also contain particulate filler which is designed to react with the polar moiety creating iconic bonding sites. The filler will also reduce the amount of energy (Joules/gram) required to melt the thermoplastic portion of the adhesive. The filler will also retain heat to allow the thermoplastic portion of the adhesive layer to remain in a molten state longer, providing more time for chemical bonds to form. The filler will also stiffen and rigify the adhesive without greatly affecting the chemical bonding the adhesive. The particulate filler can be organic or inorganic, and can constitute from about 0.1% to about 75% by weight of the total adhesive composition, preferable from about 6% to about 45% by weight, most preferable from about 10% to about 20% by weight.

The filler particle size will affect the percentage of filler used in the adhesive. Particle sizes with an average diameter less than 1 micron require percentages less than 3% by weight. This is due to an increase in surface area of smaller particle sizes allowing for more reactions to occur between the polar functional moiety and the particulate filler. The greater the amount of surface area, the less percent filler by weight is required to get an equivalent ionic bond. Particulate fillers include but are not limited to, talc, mica, alumina, wallastonite, clay, glass sphere, titania, silicates, phosphate, wood flour, and mixtures thereof. These fillers are preferred as they react with the polar moiety forming ionic bonding sites.

An oxo-anion of silicate in a lattice structure is presently most preferred with the ability to react and have a negative charge of four or greater, having a minimum of four potential ionic bonding sites. It is anticipated that not all potential bonding sites will become available. Silicates can form several lattice structures with varying degrees of ionic bonding sites. Examples of these silicate molecules include nesosilicates, sorosilicates, cyclosilicates, inosilicates, inosilicates.

An important feature of the filler is that it is not to be allowed to react excessively with the polar functional moiety in the adhesive. This would result in more of the polar functional moiety reactive sites being used up than are required to achieve sufficient ionic bonding sites. In case of high percentages of particulate filler, a large percentage of the polar functional moiety would be used up bonding to the particulate filler as a result of super saturation, rendering these moieties inert and unable to covalent bond to the metal surface.

One way to control such a reaction is to chemically balance the percentage of filler by weight against the percent polar moiety by weight based on the number of potential active sites on the filler that the polar moiety can react with. Another method is to coat an otherwise reactive filler with a less reactive or inert material (steric acid, behenic acid, mineral oil and so on) which physically shields the filler from the polar functional moiety from the majority of the polar moiety. Even after coating the particulate filler, some reaction is still expected between the filler and polar moiety. It is preferred that from about 5% to about 15% of the polar functional moiety react with the particulate filler to allow ionic bonding sites.

The amount of particulate filler used depends upon the strength and amount of the polar functional moiety reacted with the backbone polymer in the active ingredient (which affects how much, if any, of the active ingredient can be diluted). The adhesive composition may optionally contain one or more additional thermoplastic polyolefin-type polymers and co-polymer which are not reacted with a polar functional moiety. The unreacted polymer may simply serve as a diluent for the reacted polymer, and may include any of the polymers previously listed above as polymer backbones. The unreacted polymer may also serve as an adhesion promoter, and may include soft or rubbery materials such as ethylene-propylene rubber, butane-1 polymers and copolymers, ethylene vinyl acetate, and other soft materials. These softer materials help to evenly disperse the energy put into the thermoplastic adhesive. When used, the optional additional polymer or polymers may conspolymer from about 1% to about 96% by weight of the adhesive composition.

Whether or not an unreacted polyolefin is used, and how much, will depend on the strength and amount of the polar functional moiety reacted with the backbone polymer in the active ingredient (which affects how much, if any, of the active ingredient can be diluted). Also to be considered is how much particulate filler is added to the adhesive (which affects how much, if any, of the filler interacts with the active ingredient). Generally, the amounts and types of the active ingredient, filler, and unreacted polymer should be selected so that the amount of the functional polar moiety in the active ingredient, which is available for polar covalent bonding to the metal oxide surface and is not reacted with the filler constitutes from about 0.01% to about 5% by weight of the overall adhesive composition. Preferable, the amount of the polar functional moiety will be from about 0.02% to about 1% by weight of the adhesive composition, most preferable from about 0.03% to about 0.5% by weight.

Several known extrudable adhesives do not contain a filler component or anhydrides, esters, and amides; metal salts of unsatured carboxylic acids; and imides, and combinations thereof and are therefore not part of this disclosure. However, some of these adhesives can be mixed with a filler in the amounts stated above along with anhydrides, esters, and amides; metal salts of unsatured carboxylic acids; and imides and to create an adhesive composition capable of both polar covalent and ionic bonding and thus useful in metal sheet lamination.

Examples of these extrudable adhesives include PRIMACOR™ which is a family of low modulus, low density resins prepared by copolymerizing acrylic acid with ethylene and is available from DOW Chemical, grafted polyolefin blend with hydrocarbon elastomers, BYNEL™ is available from Du Pont™, ADMER™ is available from Mitsui Petrochemical Industries, PLEXAR™ is available from Equistar™, TYMEX™ is available from Westlake, TYMOR™ is available from Rohm & Hass, a Division of DOW Chemical. Two very useful adhesives are polar moieties containing high density polyethylene sold by Equistar under the name PLEXAR and Rohm & Hass under the name TYMOR. Again these two particular extrudable adhesives do not contain fillers as sold but can be mixed with fillers to make adhesive compositions within the scope of the disclosure.

One preferred method for making the multi-layer film is the use of a multi-layer film line utilizing a co-extrusion channel feed block with the ability to make a minimum of three layers, an adhesive layer 12, a core layer 18, and a outer layer 20. The adhesive layer 12 contains the above discussed thermoplastic adhesive formulation which may or may not also contain a particulate filler. The adhesive layer by percent of the overall film structure can be varied from about 1% to about 75% of the overall polymer film 10.

The core layer 18 can be used to change the properties of the film 10 to perform based on the application of the finished laminated metal article without impacting the performance characteristics of either adhesive 12 or outer layers 20. In one embodiment the core layer 18 may be composed of linear low density polyethylene to increase the elongation of the overall film product to make the film easier to conform around the corrugation put into a culvert pipe. In another embodiment the core layer 18 may be composed of nylon for vapor protection.

The core layer 18 is in place for the purpose of adjusting film properties without affecting the properties of the other layers. The composition of the core layer 18 has the potential to be different from application to application and customer to customer. In some instances where a core layer 18 is not needed, the core layer composition would be the same as the outer layer composition. In other instances multiple film properties are needed that a single core layer would not provide. This would require more than one core layer 20. The sum of all core layers by percent of the overall film structure can vary from about 3% to about 87%.

The outer layer 18 is general composed of a polyolefin with high abrasion resistance and good weathering properties. Of the polyolefins which are capable of being produced in conjunction with the other layers, high density polyethylene or homo-polymer polypropylene are preferred for their abrasion resistance and low friction. The outer layer 20 contains an additive to prevent oxidation and ultra-violet degradation such as Hindered Amine Light Stabilizers (HALS). The outer layer 20 is soft enough to allow for sharp bending of the metal 14 without the olefin whitening or crazing at the bend. Whitening or Crazing is a common problem with polymer film where the film is put under an excess amount of stress at a bend resulting in micro-fractures on the film surface giving the appearance the film has turned white. These micro-fractures leave the possibility of larger cracks forming exposing the metal surface. Another way to overcome the “whitening” effect is to increase the overall thickness of the outer layer 20, allowing for more absorption of the strain by the olefin. The outer layer by percent of the overall film structure can vary from about 3% to about 96%.

As shown in FIG. 2, after the metal, 14, is conveyed out of the oven it is run through two lamination rolls located on the top and bottom of the metal sheet 14. The thermoplastic film 10, wraps the lamination rolls with the adhesive side facing away from the lamination rolls but toward the metal sheet 14 surface. Under pressure from the lamination rolls, and using the remaining heat put into in the metal from the ovens, the film 10 is laminated to the metal. After only a couple of seconds a chemical bond has started to form between the metal 14 and the thermoplastic adhesive 12. The metal/film composite is further conveyed into a water tank where the composite article is cooled to room temperature before being wound into a roll.

A metal pipe made in accordance with the present disclosure offers improved properties over tar and Dow Trenchcoat™. In particular, the present disclosure creates a direct chemical bond between the metal sheet 14 and the polymer film 10 in a one pass setup without the need for primers. As a result the metal sheet 14 is better protected from the elements, chemicals, and abrasion. Further, the particulate filler allows for faster line speeds and colder oven temperatures for lamination. Faster line speeds and colder oven temperatures both have advantages as one results in increased production and the other saves on energy costs. Finally the current disclosure is more chemical and abrasion resistant through the use of high density polyethylene in the outer layer 20.

### Example 1

A cast film extrusion was used to prepare a two layer polymer film 10 comprising an adhesive layer 12 and an outer layer 20. The overall thickness average of the polymer film 10 was twelve mils. The adhesive layer 12 constituted 10% by volume based on total polymer film thickness. The adhesive layer 12 was composed of a Plexar™ resin acquired in pellet form with the active ingredient of maleic anhydride grafted to high density polyethylene, 50% by weight of the adhesive layer and 10% of the overall film volume. The Plexar™ resin contained less than 5% maleic anhydride grafted to the polymer back bone and less than 10% soft rubber. The adhesive layer 12 included 16.5% of a particulate filler (talc) having a particle size of 5 microns. The remaining 33.5% of the adhesive layer formulation included a non-reactive high density polyethylene with no functional groups attached to the backbone.

The outer layer 20 of the polymer film 10 constituted 90% by volume of the total film thickness and was composed of 92% high density polyethylene by weight of the outer layer 20 with 5% black color pigmentation and 3% ultra violet inhibitor. Both layers were processed using single screw extruders. The molten polymer was directed into a co-extrusion feed block and through a common sheet hanger die used in film extrusion. The film was laminated to 0.002″ steel sheeting at 375F, 400F, 425F, and 450F at 40 PSI and a heat dwell time of 4.5 seconds. Laboratory testing using a tensile tester showed the following results:

| | |
|---|---|
| 375 F. | 3.028 lbs/sq in |
| 400 F. | 5.615 lbs/sq in |
| 425 F. | 6.656 lbs/sq in |
| 450 F. | Melded to Metal |

In cases where the temperature reached 450F the film was so greatly bonded to the metal that the film tore at the heat-seal point and would not pull away from the metal surface.

Further the film was laminated to 0.002″ steel sheeting at 425F and 40PSI but varying the heat dwell time. Laboratory testing using a tensile tester showed the following results:

| | | | |
|---|---|---|---|
| 1 | sec | 0 | lbs/sq in |
| 2 | sec | 0.687 | lbs/sq in |
| 3 | sec | 0.841 | lbs/sq in |
| 4 | sec | 2.016 | lbs/sq in |
| 5 | sec | 3.375 | lbs/sq in |
| 6 | sec | 6.145 | lbs/sq in |

| | | |
|---|---|---|
| 7 | sec | Melded to Metal |
| 8 | sec | Melded to Metal |
| 9 | sec | Melded to Metal |
| 10 | sec | Melded to Metal |

In cases where dwell time reached seven seconds the film was so greatly bonded to the metal that the film tore at the heat-seal point and would not pull away from the metal surface. Abrasion testing was performed according to ASTM D4060-10 Standard Test Method for Abrasion Resistance of Organic Coatings by the Taber Abraser. Results show the difference in DOW Trechcoat vs the current disclosure after 1000 cycles using CS-17 wheels.

| | | Current |
|---|---|---|
| | Trenchcoat | Disclosure |
| Weight Loss | 14.8 mg | 4.1 mg |

The lower weight loss shows the current disclosure is significantly more abrasion resistant.

### Example 2

In yet another example, the particulate filler percentage was decreased and bond strength was measured. Using cast film extrusion to prepare a two layer polymer film 10, an adhesive layer 12 and an outer layer 20. The overall thickness average of 12 mils. The adhesive layer constituted 25% by volume based on total film thickness. The adhesive layer 12 was composed of a PLEXAR resin in pellet form with the active ingredient of maleic anhydride grafted to high density polyethylene, 50% by weight of the adhesive layer 12, 10% of the overall film volume. The Plexar resin contained less than 5% maleic anhydride grafted to the polymer back bone and less than 10% soft rubber. The particulate filler (talc), with a particle size of 5 microns, was added to the adhesive layer but reduced to 9% by weight.

The remaining 41% of the adhesive layer 12 formulation was a non-reactive high density polyethylene with no functional groups attached to the backbone. The outer layer constituted 75% by volume based on total film thickness and was composed of 92% high density polyethylene by weight of the outer layer with 5% black color pigmentation and 3% ultra violet inhibitor. Both layers were processed using single screw extruders. The molten polymer was directed into a co-extrusion feedblock and through a common sheet hanger die used in film extrusion. The film was laminated to 0.002″ steel sheeting at 375F, 400F, 425F, and 450F at 40 PSI and a heat dwell time of 4.5 seconds. Laboratory testing using a tensile tester showed the following results:

| | | |
|---|---|---|
| 375 F. | 0 | lbs/sq in |
| 400 F. | .412 | lbs/sq in |
| 425 F. | 1.02 | lbs/sq in |
| 450 F. | 4.153 | lbs/sq in |

Further the film was laminated to 0.002″ steel sheeting at 425F and 40PSI but varying the heat dwell time. Laboratory testing using a tensile tester showed the following results:

| | | | |
|---|---|---|---|
| 1 | sec | 0 | lbs/sq in |
| 2 | sec | .313 | lbs/sq in |
| 3 | sec | .868 | lbs/sq in |
| 4 | sec | 1.14 | lbs/sq in |
| 5 | sec | 2.27 | lbs/sq in |
| 6 | sec | 2.79 | lbs/sq in |
| 7 | sec | 2.95 | lbs/sq in |
| 8 | sec | 2.86 | lbs/sq in |
| 9 | sec | 9.56 | lbs/sq in |

| | | |
|---|---|---|
| 10 | sec | Melded to Metal |

This example was conducted to illustrate the effects that the particulate filler has on the overall bond strength by creating ionic bonding sites.

### Example 3

In order to demonstrate the effect that the overall thickness has on energy absorption the formula and structure from Example 1 was used but with the overall thickness reduced from 12 mil to 2 mil.

The film was laminated to 0.002″ steel sheeting at 275F, 300F, 325F, and 350F at 40 PSI and a heat dwell time of 4.5 seconds. Laboratory testing using a tensile tester showed the following results:

| | | |
|---|---|---|
| 275 F. | 0 | lbs/sq in |
| 300 F. | 2.88 | lbs/sq in |
| 325 F. | 3.153 | lbs/sq in |

| | |
|---|---|
| 350 F. | Melded to Metal |

In cases where the temperature reached 350F the film was so greatly bonded to the metal that the film tore at the heat-seal point and would not pull away from the metal surface. This example demonstrates that by using less overall volume of material the amount of energy/heat required to melt the polymer film faster and move bonds to the metal surface is reduced.

### Example 4

As a final example, the film of Example 3 was modified by reducing the active ingredient by 50% and grafting it to linear low density polyethylene, the bonds were tested. The film was laminated to 0.002″ steel sheeting at 275F, 300F, 325F, and 350F at 40 PSI and a heat dwell time of 4.5 seconds. Laboratory testing using a tensile tester showed the following results:

| | | |
|---|---|---|
| 275 F. | 0.5 | lbs/sq in |
| 300 F. | 1.24 | lbs/sq in |
| 325 F. | 3.989 | lbs/sq in |

| | |
|---|---|
| 350 F. | Melded to Metal |

This example demonstrates that using a lower melting polymer with less active ingredient will allow for a similar strength bond comparable to Example 3 between the metal and polymer backbone of the adhesive layer.

While embodiments have been illustrated and described in the drawings and foregoing description, such illustrations and description are considered to be exemplary and not restrictive in character, it being understood that only illustrative embodiments have been shown and described and that all changes and modifications that come within the spirit of the disclosure are desired to be protected. The applicants have provided description and Fig.s which are intended as illustrations of embodiments of the disclosure, and are not intended to be construed as constraining or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure.

What is claimed is:

1. A multi-layer polymer film for laminating to a metal surface the multi-layer polymer film consisting of:
a thermoplastic adhesive layer formed from an extrudable polyolefin containing a functional polar moiety and including from about 0.1% to about 75% by weight of a particulate filler, the thermoplastic adhesive layer, when heated, is configured to allow a polar covalent chemical bond to form between a polymer backbone of the extrudable polyolefin and the metal surface by the functional polar moiety, wherein the particulate filler is configured to reduce the amount of heat energy required to bond the thermoplastic adhesive layer to the metal; and
an outer surface layer formed from high density polyethylene or homo-polymer polypropylene, wherein the outer surface layer is configured to assist in protecting the metal surface.

2. The multi-layer polymer film of claim 1, further including a core layer formed from a linear low density polyethylene.

3. The multi-layer polymer film of claim 1, wherein the polymer film is heat laminated to the metal sheeting to form a protective barrier.

4. The multi-layer polymer film of claim 1, wherein the polyer film can be heat laminated to the outer surface of an already formed metal pipe.

5. The multi-layer polymer film of claim 1, wherein the thermoplastic adhesive layer may include from about 1% to about 96% rubbery materials.

6. The multi-layer polymer film of claim 5, wherein the thermoplastic adhesive layer includes rubbery materials from the group consisting of ethylene-propylene rubber, butane-1 polymers and copolymers and ethylene vinyl acetate, which are used to disperse heat energy put into the thermoplastic adhesive layer.

7. The multi-layer polymer film of claim 1, wherein the particulate filler is configured to redox react with a small amount of the functional polar moiety to open up ionic bonding sites to allow ionic bonding to occur between the particular filler and the metal surface.

8. The multi-layer polymer film of claim 1, wherein the particulate filler holds and stores heat energy put into the polymer film article longer than the surrounding thermoplastic adhesive material.

9. The multi-layer polymer film of claim 1, wherein the heat energy stored in the particulate filler from lamination is slowly released in the form of heat to increase the time required for the surrounding molten thermoplastic adhesive to re-solidify.

10. The multi-layer polymer film of claim 9, wherein the slowed cooling and re-solidification of the molten thermoplastic adhesive allows for more covalent and ionic bonds to form between the adhesive layer and the metal surface.

11. The multi-layer polymer film of claim 1, wherein the filler contains particles from the group consisting of talc, mica, alumina, wallastonite, clay, glass sphere, titania, nesosilicates, sorosilicates, cyclosilicates, inosilicates, inosilicates, silicates, phosphates, wood flour, and combinations thereof.

12. The multi-layer polymer film of claim 1, wherein the filler has an average particle diameter from about 0.1 microns to about 100 microns.

13. The multi-layer polymer film of claim 1, wherein the extrudable polyolefin is selected from the group consisting of polyethylene, polypropylene, copolymers of ethylene with alpha-olefins, copolymers of ethylene with ethelenically unsatured esters and their derivatives, and combinations thereof.

14. The multi-layer polymer film of claim 1, wherein the functional polar moiety comprises an active ingredient selected from the group consisting of unsatured carboxylic acids, functional derivatives of carboxylic acids including anhydrides, esters, and amides, metals salts of unsatured carboxylic acids, imides and combinations thereof.

15. The multi-layer polymer film of claim 1, wherein the outer layer is formed to include a low friction surface.

16. A method of forming polymer coated metal sheeting having increased abrasion and corrosion resistance, the method comprising the steps of:
heating metal sheeting to at least 275 degrees F.;
applying a multi-layer polymer film to at least one surface of the heated metal sheeting, the multi-layer polymer film comprising a thermoplastic adhesive layer formed from an extrudable polyolefin containing a functional polar moiety and including from about 0.1% to about 75% by weight of a particulate filler and an outer surface layer formed from high density polyethylene or homo-polymer polypropylene;
allowing a portion of the thermoplastic adhesive layer to reach a molten state to permit the thermoplastic adhesive layer to bond to the metal sheeting; and
cooling the metal sheeting and polymer film.

17. The method of claim 16, wherein the multi-layer polymer film further includes a core layer formed from a linear low density polyethylene.

18. The method of claim 16, further including the step of forming the metal sheeting containing the polymer film is formed into pipe.

19. The method of claim 16, wherein the thermoplastic adhesive layer includes rubbery materials from the group consisting of ethylene-propylene rubber, butane-1 polymers and copolymers and ethylene vinyl acetate, which are used to disperse heat energy put into the thermoplastic adhesive layer.

20. The method of claim 16, wherein the particulate filler is configured to redox react with a small amount of the functional polar moiety to open up ionic bonding sites to allow ionic bonding to occur between the particular filler and the at least one surface.

21. The method of claim 16, wherein the filler contains particles from the group consisting of talc, mica, alumina, wallastonite, clay, glass sphere, titania, nesosilicates, sorosilicates, cyclosilicates, inosilicates, inosilicates, silicates, phosphates, wood flour, and combinations thereof.

22. The method of claim 21, wherein the filler has an average particle diameter from about 0.1 microns to about 100 microns.

23. The method of claim 16, wherein the extrudable polyolefin is selected from the group consisting of polyethylene, polypropylene, copolymers of ethylene with alpha-olefins, copolymers of ethylene with ethelenically unsatured esters and their derivatives, and combinations thereof.

24. The method of claim 23, wherein the functional polar moiety comprises an active ingredient selected from the group consisting of unsatured carboxylic acids, functional derivatives of carboxylic acids including anhydrides, esters, and amides, metals salts of unsatured carboxylic acids, imides and combinations thereof.

25. A method of forming a polymer coated metal pipe having increased abrasion and corrosion resistance, the method comprising the steps of:
heating metal pipe to at least 275 degrees F.;
applying a multi-layer polymer film to at least one surface of the heated metal pipe, the multi-layer polymer film comprising a thermoplastic adhesive layer formed from an extrudable polyolefin containing a functional polar moiety and including from about 0.1% to about 75% by weight of a particulate filler and an outer surface layer formed from high density polyethylene or homo-polymer polypropylene;
allowing a portion of the thermoplastic adhesive layer to reach a molten state to permit the thermoplastic adhesive layer to bond to the metal pipe; and
cooling the metal pipe and polymer film.
